(19) United States
(12) Patent Application Publication
(10) Pub. No.: US 2009/0223948 A1
(43) Pub. Date: Sep. 10, 2009

(54) MAGNETIC WATER HEATER

(76) Inventor: Randy Hess, Turlock, CA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 12/043,812

(22) Filed: Mar. 6, 2008

(51) Int. Cl. H05B 6/10; H01M 10/44; F24J 3/00; H02P 7/00

(52) U.S. Cl. 219/628; 320/101; 318/139; 219/630; 219/672

(57) ABSTRACT

A heater includes a first rotor rotatably mounted to a support structure, and a first magnet attached to the first rotor. A second rotor is rotatably mounted to the support structure to be substantially coaxial with the first rotor, and a second magnet is attached to the second rotor. A tank that is at least partially formed from an electrically conductive material is disposed between the first rotor and the second rotor. A drive mechanism is configured to rotate the first rotor in a first direction and the second rotor in a second direction opposite the first direction.

### TECHNICAL FIELD

The disclosed subject matter relates generally to devices used to heat fluids, and more specifically, to heaters that that utilize magnets to generate heat.

### BACKGROUND

Known water heaters generally utilize electrical heating elements or combustion of fossil fuels to generate heat. Electrical heating elements are known to be inefficient and costly to operate. Fossil fuel combustion is inefficient, costly, and often requires complex and costly exhaust systems to transport exhaust gases to a safe discharge location.

Permanent magnet heaters are a known alternative to electrical heating elements and fossil fuel burners. Permanent magnet heaters subject an electrical conductor to a changing magnetic field, thereby producing eddy currents, i.e., a circulating flow of electrons, within the conductor. The flow of the current through the conductor is resisted by the resistance of the conductor, which produces heat. Known magnetic heaters create eddy currents in a stationary conductor by moving permanent magnets relative to a fixed conductor. The heat generated by the eddy currents is then used to heat water. However, a problem exists in that known permanent magnet heaters are inefficient, complex, and cost-prohibitive.

### SUMMARY

A first embodiment of a disclosed heater includes a first rotor and a second rotor rotatably mounted to a support structure so that the first rotor is substantially coaxial with the second rotor. Each rotor has a magnet attached thereto. A tank is at least partially formed from an electrically conductive material and is located between the first and second rotors. The heater further includes a drive mechanism to rotate the first rotor in a first direction and the second rotor in a second direction opposite the first direction.

Also disclosed is a water heater having a first rotor and a second rotor rotatably mounted to a support structure so that the first rotor is substantially coaxial with the second rotor. Each of the first and second rotors has a magnet attached thereto. A tank is at least partially formed from an electrically conductive material and is located between the first and second rotors. The heater further includes a storage unit in fluid communication with the tank. A drive mechanism rotates the first rotor and the second rotor in opposite directions to heat the water in the heater tank. Water from the storage unit is passed through the tank to maintain water in the storage unit within a selected temperature range.

A disclosed forced air heater includes a first rotor and a second rotor rotatably mounted to a support structure so that the first rotor is substantially coaxial with the second rotor. Each of the first and second rotors has a magnet attached thereto. A tank is at least partially formed from an electrically conductive material and is located between the first and second rotors. The heater further includes a heater core in fluid communication with the tank. Fluid from the heater core is passed through the tank to heat the fluid, and then returned to the heater core, thereby raising the temperature of the heater core. A fan is positioned proximate to the heater core and creates a flow of air across the heater core.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### DESCRIPTION OF THE DRAWINGS

The foregoing aspects and many of the attendant advantages of this invention will become more readily appreciated by reference to the following detailed description, when taken in conjunction with the accompanying drawings, wherein:

FIG. 1 is a side view of an exemplary embodiment of a water heater using a magnetic heater according to the present disclosure;

FIG. 2 is an end view of the water heater shown in FIG. 1;

FIG. 3 is a side view of a first rotor of the water heater shown in FIG. 2;

FIG. 4 is a side view of a second rotor of the water heater shown in FIG. 2;

FIG. 5 is a side view of an alternate embodiment of a rotor of the water heater shown in FIG. 2; and

FIG. 6 is side view of an exemplary embodiment of a forced air heater using the heater shown in FIG. 1.

### DETAILED DESCRIPTION

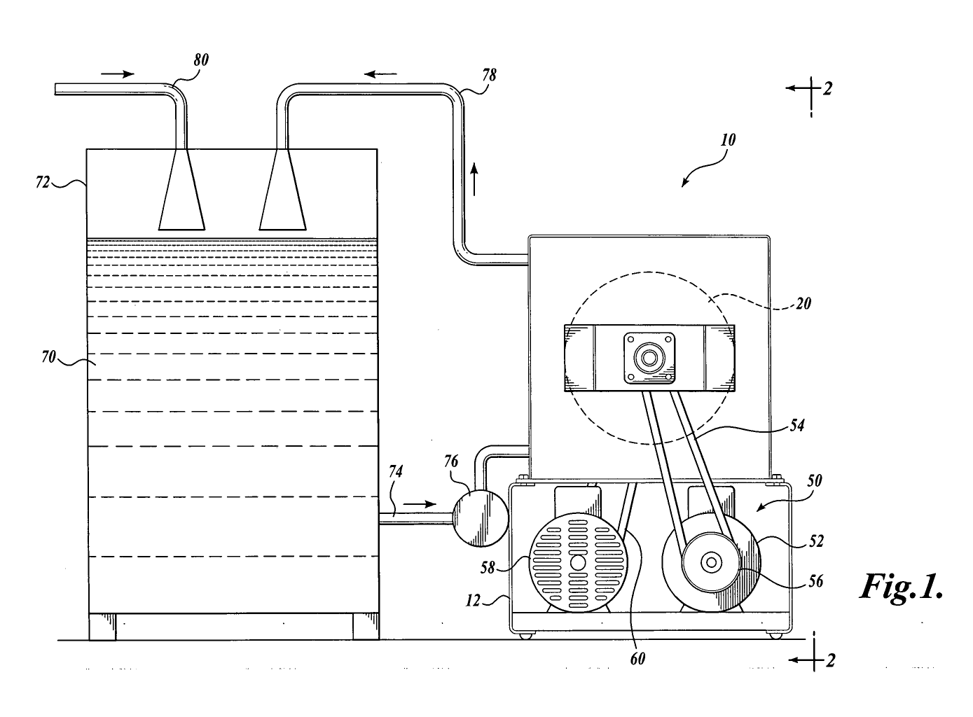

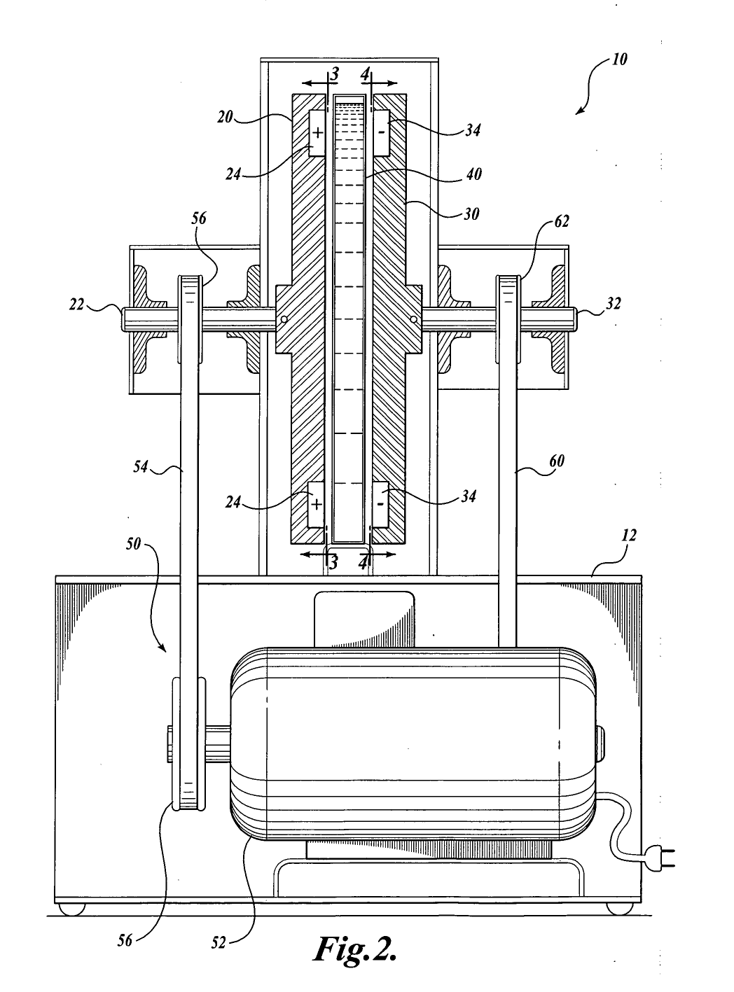

Referring to FIGS. 1 and 2, an exemplary embodiment of a disclosed magnetic heater 10 includes a support structure 12 with a first rotor 20 rotatably coupled thereto by a first axle 22. The rotor 20 is disk-shaped, and the axle 22 is secured to a side of the rotor 20 so that the axle 22 extends in a perpendicular direction from a central portion of the rotor 20.

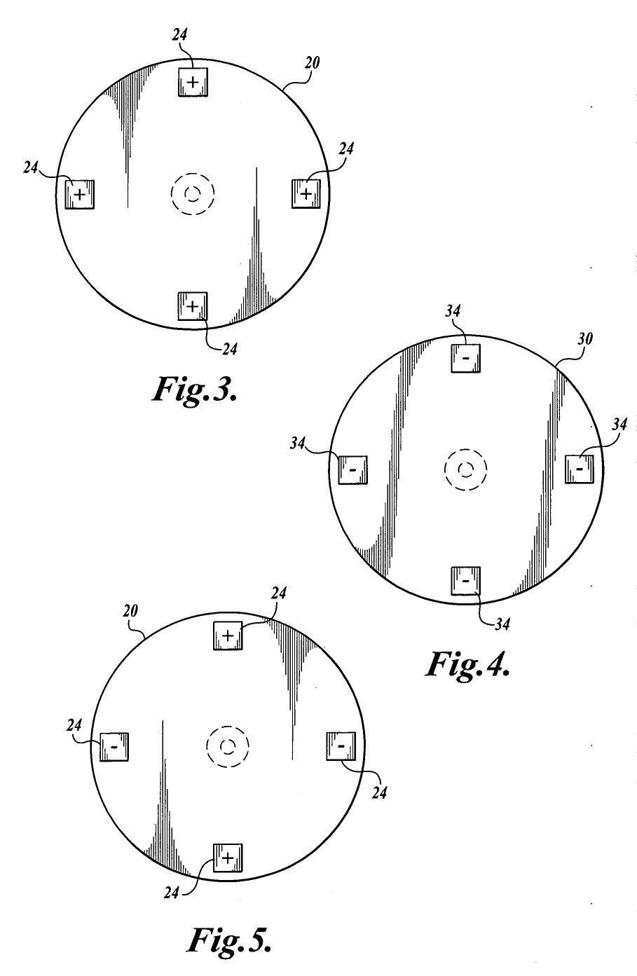

A plurality of permanent magnets 24 is disposed on the face of the rotor 20 opposite the side to which the axle 22 is secured. As shown in FIG. 3, the magnets 24 are positioned circumferentially around the face of the first rotor 20 and are oriented so the magnets 24 all exhibit the same polarity. In the illustrated embodiment, a plurality of magnet seats are machined into the face of the rotor 20, and a magnet 24 having a square cross-section is press fit into each magnet seat. It should be appreciated, however, that the magnets 24 can be secured to the rotor by any suitable means, including adhesives, mechanical fasteners, mounting hardware, or any combination thereof without departing from the scope of the disclosure. Further, alternate embodiments that utilize different numbers of magnets 24, as well as magnets 24 having different sizes, shapes, positions, and orientations should also be considered within the scope of the disclosed subject matter.

Referring back to FIG. 2, a second rotor 30, which is similar to the first rotor 20, is rotatably mounted to the support structure 12 by an axle 32. The second rotor 30 is disk-shaped, and the axle 32 is secured to a side of the rotor 30 so that the axle 32 extends in a perpendicular direction from the center of the rotor 30. The second rotor 30 is mounted to the support structure 12 so that the face of the second rotor 30 opposes the face of the first rotor 20. When the second rotor 30 is so mounted, the axles 22 and 32 of the first and second rotors 20 and 30 extend in opposite directions, and are substantially coaxial with each other.

As shown in FIGS. 2 and 4, a plurality of magnets 34 is disposed on the face of the second rotor 30 opposite the side to which the axle 32 is secured. Similar to the magnets 24 of the first rotor 20, the magnets 34 of the second rotor 30 are positioned circumferentially around the face of the rotor 30 and are oriented so that all of the magnets 34 exhibit the same polarity; however, the polarity exhibited by the magnets 24 disposed on the first rotor 20 is opposite to the polarity exhibited by the magnets 34 disposed on the second rotor 30. Although the polarities of the magnets 24 of the first rotor 20 and the magnets 34 of the second rotor 30 are opposite, the number and arrangement of magnets 34 in the illustrated embodiment are the same as the number and arrangement of the magnets 24 on the first rotor 20. Alternate embodiments are contemplated, wherein the number and arrangement of magnets 24 and 34 vary between the first and second rotors 20 and 30, respectively, and such embodiments should be considered within the scope of the present disclosure.

In an alternate embodiment of the first and second rotors 20 and 30, magnets disposed on the face of a given rotor exhibit opposite polarities. Referring to FIG. 5, the magnets 24 positioned circumferentially around the face of the first rotor 20 are oriented so that adjacent magnets 24 on the face of the rotor 20 exhibit opposite polarities. Similarly, the magnets 34 positioned circumferentially around the face of the second rotor 30 are oriented so that adjacent magnets 34 on the face of the second rotor 30 exhibit opposite polarities.

Referring back to FIG. 2, a tank 40 is disposed between the first and second rotors 20 and 30. In the disclosed embodiment, the tank 40 has opposing parallel walls, each wall corresponding to and being generally parallel to one of the first and second rotors 20 and 30. The tank 40 is constructed of an electrically conductive material, such as copper, and is located in close enough proximity to the first and second rotors 20 and 30 so that relative motion between either rotor 20 or 30 and the tank 40 produces eddy currents in the tank material. In alternate embodiments, only the portions of the tank 40 positioned near the rotors 20 and 30 are formed from an electrically conductive material.

The heater 10 includes a drive system 50 for rotating the rotors 20 and 30 relative to the tank 40. The illustrated drive system 50 includes a first motor 52 secured to the support structure 12 and a pulley 56 coupled to the drive shaft of the motor 52. A belt 54 forms an endless loop that engages the pulley 56 coupled to the drive shaft of the motor 52 and also, a second pulley 56 coupled to the axle 22 of the first rotor 20. As a result, rotation of the drive shaft turns the belt 54, which in turn rotates the axis 22 and the first rotor 20.

As shown in FIGS. 1 and 2, the drive system 50 further includes a second motor 58 secured to the support structure 12 and a pulley (not shown) coupled to the drive shaft of the second motor 58. A second belt 60 forms an endless loop that operably engages the pulley coupled to the drive shaft of the second motor 58 and also, a pulley 62 coupled to the axle 32 of the second rotor 30. In operation, the first motor 52 drives the first pulley 56 to rotate the first rotor 20 in a first direction, and the second motor 58 drives the second pulley 62 to rotate the first rotor in a second direction that is opposite the first direction.

Various embodiments of the drive assembly are possible and should be considered within the scope of the disclosure. In one exemplary embodiment, the motors 52 and 58 are powered by a DC current from a standard power supply. In alternate embodiments, the motors 52 and 58 are powered by one or more batteries 94 that are charged by solar panels 96, thus eliminating the need for an external power supply. In yet another alternate embodiment, the belts 54 and 60 and the pulleys 56 and 62 are replaced with gears, chains and sprockets, a direct coupling to the motor drive shaft, or any other know method of transmitting rotational force from the motor drive shaft to the rotor axles 22 and 32. In addition, a single motor is optionally adapted to drive both rotors 20 and 30.

As the first and second rotors 20 and 30 rotate in opposite direction, the motion of the magnets 34 and 24 associated with each rotor create a magnetic vortex inside the tank 40. The magnetic vortex, in turn, induces eddy currents in the conductive portions of the tank 40. Heat created by the eddy currents increases the temperature of the tank 40. As a result, water or any other fluid inside the tank is heated.

The rotational speed of the first and second rotors 20 and 30 differs for various embodiments. In one exemplary embodiment, the rotors 20 and 30 rotate at a speed of between 1500 and 1700 revolutions per minute. It should be appreciated, however, that the rotational speed of the rotors 20 and 30 can be varied to optimize performance for a particular embodiment.

The described heater 10 is suitable for use in several applications. In the embodiment shown in FIG. 1, the magnetic heater 10 is used to maintain water 70 in a storage unit 72 at an elevated temperature. Water 70 is discharged from the storage unit 72 and is received into the tank 40 of the heater 10 via an intake pipe 74. A water pump 76 is provided to pump the water 70 from the storage unit 72 to the tank 40. Alternately, the storage unit 72 is positioned above the tank 40 so that water 70 passes from the storage unit 72 to the tank 40 via gravity feed.

Water 70 from the storage unit 72 is heated in the tank 40 of the magnetic heater 10. The heated water is discharged from the tank 40 and is returned to storage unit 72 via a hot water outlet pipe 78. When water 70 from the storage unit 72 is used, replacement water is supplied to the storage unit 72 by a replacement water inlet 80. The replacement water mixes with the water 70 in the storage unit 72, and is subsequently heated by the magnetic heater 10. By utilizing a thermostat to control the frequency and rate at which water from the storage unit 72 is removed, heated, and returned to the storage unit 72, the temperature of the water 70 in the storage unit 72 can be maintained within a desired range.

In an alternate embodiment, the magnetic heater 10 is used to heat a swimming pool so that the temperature of the water is maintained within a desired range. This embodiment is configured similar to the previously described embodiment in which water is a storage unit 72 is heated, with main difference being that a swimming pool takes the place of the previously described storage unit 72. Other modifications to adapt the system for use with a swimming pool would be within the knowledge of one of skill in the art and should be considered within the scope of the present disclosure.

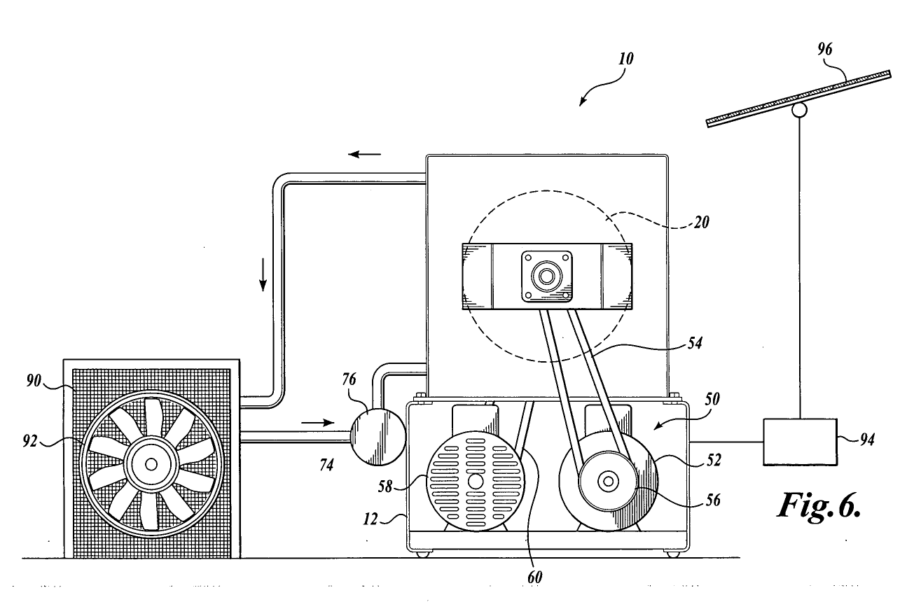

FIG. 6 shows still another alternate embodiment, in which the magnetic heater 10 is adapted to be used with a known heater core 90 in a forced air heater. The magnetic heater 10 heats fluid within the heater core 90, and a fan 92 blows air across an external portion of the heater core 90. The resulting flow of heated air can be used to heat a building, such as a home, thereby replacing or supplementing a standard furnace. As a result, embodiments that use motors powered by batteries 94 charged by solar panels 96, as shown in FIG. 6, can heat houses or other buildings without burning fossil fuels or requiring an outside power source.

While illustrative embodiments have been illustrated and described, it will be appreciated that various changes can be made therein without departing from the spirit and scope of the invention.

The embodiments of the invention in which an exclusive property or privilege is claimed are defined as follows:

1. A heater, comprising:
(a) a support structure;
(b) a first rotor rotatably mounted to the support structure, a first magnet being attached to the first rotor;
(c) a second rotor rotatably mounted to the support structure, the second rotor being substantially coaxial with the first rotor, a second magnet being attached to the second rotor;
(d) a tank disposed between the first rotor and the second rotor, the tank being at least partially formed from an electrically conductive material; and
(e) a drive mechanism configured to rotate the first rotor in a first direction and the second rotor in a second direction opposite the first direction.

2. The heater of claim 1, further comprising a first plurality of magnets attached to the first rotor and a second plurality of magnets attached to the second rotor.

3. The heater of claim 2, wherein the first plurality of magnets is arranged around a perimeter of the first rotor, each of the first plurality of magnets being oriented to exhibit a first polarity, and wherein the second plurality of magnets is arranged around a perimeter of the second rotor, each of the second plurality of magnets being oriented to exhibit a second polarity opposite the first polarity.

4. The heater of claim 2, wherein the first plurality of magnets is arranged around a perimeter of the first rotor, each of the first plurality of magnets being oriented to exhibit an opposite polarity than an adjacent magnet of the first plurality of magnets, and wherein the second plurality of magnets is arranged around a perimeter of the second rotor, each of the second plurality of magnets being oriented to exhibit an opposite polarity than an adjacent magnet of the second plurality of magnets.

5. The heater of claim 1, wherein the drive mechanism comprises an electric motor.

6. The heater of claim 5, wherein the drive mechanism further comprises:
(a) a battery; and
(b) a solar panel for charging the battery.

7. The heater of claim 1, wherein the first rotor and the second rotor rotate at a rotational speed between 1500 revolution per minute and 1700 revolutions per minute.

8. A water heater, comprising:
(a) a support structure;
(b) a first rotor rotatably mounted to the support structure, a first magnet being attached to the first rotor;
(c) a second rotor rotatably mounted to the support structure, the second rotor being substantially coaxial with the first rotor, a second magnet being attached to the second rotor;
(d) a tank disposed between the first rotor and the second rotor, the tank being at least partially formed from an electrically conductive material;
(e) a drive mechanism configured to rotate the first rotor in a first direction and the second rotor in a second direction opposite the first direction; and
(f) a storage unit in fluid communication with the tank, wherein water from the storage unit is passed through the tank to maintain water in the storage unit within a selected temperature range.

9. The water heater of claim 8, further comprising a first plurality of magnets attached to the first rotor and a second plurality of magnets attached to the second rotor.

10. The heater of claim 9, wherein the first plurality of magnets is arranged around a perimeter of the first rotor, each of the first plurality of magnets being oriented to exhibit a first polarity, and wherein the second plurality of magnets is arranged around a perimeter of the second rotor, each of the second plurality of magnets being oriented to exhibit a second polarity opposite the first polarity.

11. The heater of claim 9, wherein the first plurality of magnets is arranged around a perimeter of the first rotor, each of the first plurality of magnets being oriented to exhibit an opposite polarity than an adjacent magnet of the first plurality of magnets, and wherein the second plurality of magnets is arranged around a perimeter of the second rotor, each of the second plurality of magnets being oriented to exhibit an opposite polarity than an adjacent magnet of the second plurality of magnets.

12. The water heater of claim 8, wherein the drive mechanism comprises an electric motor.

13. The heater of claim 12, wherein the drive mechanism further comprises:
(a) a battery; and
(b) a solar panel for charging the battery.

14. The heater of claim 8, wherein the first rotor and the second rotor rotate at a rotational speed between 1500 revolution per minute and 1700 revolutions per minute.

15. A forced air heater, comprising:
(a) a support structure;
(b) a first rotor rotatably mounted to the support structure, a first magnet being attached to the first rotor;
(c) a second rotor rotatably mounted to the support structure, the second rotor being substantially coaxial with the first rotor, a second magnet being attached to the second rotor;
(d) a tank disposed between the first rotor and the second rotor, the tank being at least partially formed from an electrically conductive material;
(e) a drive mechanism configured to rotate the first rotor in a first direction and the second rotor in a second direction opposite the first direction;
(f) a heater core in fluid communication with the tank, wherein fluid from the heater core is passed through the tank to heat the fluid from the heater core; and
(g) a fan positioned proximate to the heater core, the fan creating a flow of air across the heater core.

16. The heater of claim 15, further comprising:
(a) a first plurality of magnets arranged around a perimeter of the first rotor, each of the first plurality of magnets being oriented to exhibit a first polarity; and
(b) a second plurality of magnets arranged around a perimeter of the second rotor, each of the second plurality of magnets being oriented to exhibit a second polarity opposite the first polarity.

17. The heater of claim 15, further comprising:
(a) a first plurality of magnets arranged around a perimeter of the first rotor, each of the first plurality of magnets being oriented to exhibit an opposite polarity than an adjacent magnet of the first plurality of magnets; and
(b) a second plurality of magnets arranged around a perimeter of the second rotor, each of the second plurality of magnets being oriented to exhibit an opposite polarity than an adjacent magnet of the second plurality of magnets.

18. The heater of claim 15, wherein the drive mechanism comprises an electric motor.

19. The heater of claim 18, wherein the drive mechanism further comprises:
(a) a battery; and
(b) a solar panel for charging the battery.

20. The heater of claim 15, wherein the first rotor and the second rotor rotate at a rotational speed between 1500 revolution per minute and 1700 revolutions per minute.
